(19) United States
(12) Patent Application Publication
(10) Pub. No.: US 2011/0169710 A1
(43) Pub. Date: Jul. 14, 2011

(54) CROSS-POLARIZED ANTENNA

(75) Inventor: Tso-Hua LIN, Hsinchu (TW)

(73) Assignee: SMARTANT TELECOM CO., LTD., Jhudong Township (TW)

(21) Appl. No.: 12/026,280

(22) Filed: Feb. 5, 2008

(51) Int. Cl. H01Q 21/24

(52) U.S. Cl. 343/853

(57) ABSTRACT

A cross-polarized antenna includes a substrate, a first impedance converter, a second impedance converter, a first cross-polarized antenna, and a second cross-polarized antenna. The first cross-polarized antenna has a first opening corresponding to a second opening in the second cross-polarized antenna, in which the two openings cross each other in space without contacting. The antenna is capable of receiving electromagnetic waves from different polarization directions effectively, thereby reducing the polarization loss. Besides, as the antenna is integrally formed, the manufacturing and assembling process thereof are simplified, thus lowering the manufacturing cost.

### BACKGROUND OF THE INVENTION

1. Field of Invention

The present invention relates to an antenna, and more particularly to a cross-polarized antenna formed by crossing two integrally formed antennae.

2. Related Art

A radio-frequency (RF) signal output from a radio transmitter is first transmitted to an antenna through a feed-in line, and then radiated outward by the antenna in the form of an electromagnetic wave. When transmitted to a receiving point, the electromagnetic wave is received by another antenna, and the RF signal is then transmitted to a radio receiver through another feed-in line.

Generally, an antenna radiates electromagnetic waves to the outside, and an electromagnetic wave consists of an electric field and a magnetic field, in which the direction of the electric field is a polarization direction of the antenna. Therefore, antennae varied in polarization characteristics receive and radiate different electromagnetic waves due to their different polarization directions. If an antenna has a polarization direction different from that of a received electromagnetic wave, polarization loss may occur, and the receivable signal becomes smaller.

For example, if a vertically polarized antenna is employed to receive an electromagnetic wave in a horizontal polarization direction, the received signal becomes very small, thus resulting in polarization loss, and the polarization loss at this moment is the greatest.

Therefore, in order to reduce the polarization loss, an antenna should be able to receive signals from different polarization directions effectively.

Further, as the structure of an antenna is generally complicated, and accordingly it is the same with the manufacturing and assembling process thereof, the manufacturing and assembling process of the antenna should be simplified to lower the manufacturing cost.

### SUMMARY OF THE INVENTION

To solve the above problems of polarization loss caused by the difference between the polarization direction of an antenna and that of an electromagnetic wave received by the same, and difficulty in the manufacturing and assembling process of the antenna due to its complicated structure, the present invention is directed to a cross-polarized antenna, which is capable of receiving signals from different polarization directions effectively. Besides, as the antenna is integrally formed, the manufacturing and assembling process thereof are simplified, thus lowering the manufacturing cost.

According to an embodiment of the present invention, a cross-polarized antenna including a substrate, a first impedance converter, a second impedance converter, a first cross-polarized antenna, and a second cross-polarized antenna is provided.

The first cross-polarized antenna includes a first transmission portion, a first radiation portion, a first ground portion, a first bottom, a second ground portion, and a second radiation portion.

The second cross-polarized antenna includes a second transmission portion, a third radiation portion, a third ground portion, a second bottom, a fourth ground portion, and a fourth radiation portion.

A first opening is formed at a side edge of a first end of the first radiation portion. A second opening corresponding to the position of the first opening is formed at a side edge of a first end of the third radiation portion. The first and second cross-polarized antennae are disposed on the substrate by crossing the first opening and the second opening without contacting.

The first impedance converter for converting impedance is disposed on the substrate, clad on the first transmission portion, and electrically connected to the first cross-polarized antenna. The second impedance converter for converting impedance is disposed on the substrate, clad on the second transmission portion, and electrically connected to the second cross-polarized antenna.

The cross-polarized antenna provided by the present invention is capable of receiving signals from different polarization directions effectively, so as to reduce the polarization loss.

Further, as the first and second cross-polarized antennae of the present invention are integrally formed, the manufacturing process is simple, and each antenna can be assembled by folding various portions perpendicular to the bottom thereof. Therefore, the manufacturing process is simplified, and the cost is thus lowered.

In view of the above, the problems in the conventional art can be effectively settled by the technical solution of the present invention, so as to reduce the polarization loss and simplify the manufacturing and assembling process.

The features and practice of the preferred embodiments of the present invention will be illustrated in detail below with the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a first cross-polarized antenna of the present invention;

FIG. 2 is a schematic view of a first cross-polarized antenna of the present invention;

FIG. 3 is a schematic view of a second cross-polarized antenna of the present invention;

FIG. 4 is a schematic view of a second cross-polarized antenna of the present invention;

FIG. 5 is a schematic assembly view of the present invention;

FIG. 6 is a schematic assembly view of the present invention;

FIG. 7 is a combined view of the present invention; and

FIG. 8 is a schematic view showing an adopted frequency band and absolute gain of the present invention.

### DETAILED DESCRIPTION OF THE INVENTION

The cross-polarized antenna provided by the present invention is mainly constituted by a first cross-polarized antenna 100, a second cross-polarized antenna 200, a substrate 300, a first impedance converter 400, and a second impedance converter 500. First of all, the structure and components of the first cross-polarized antenna 100 are illustrated below.

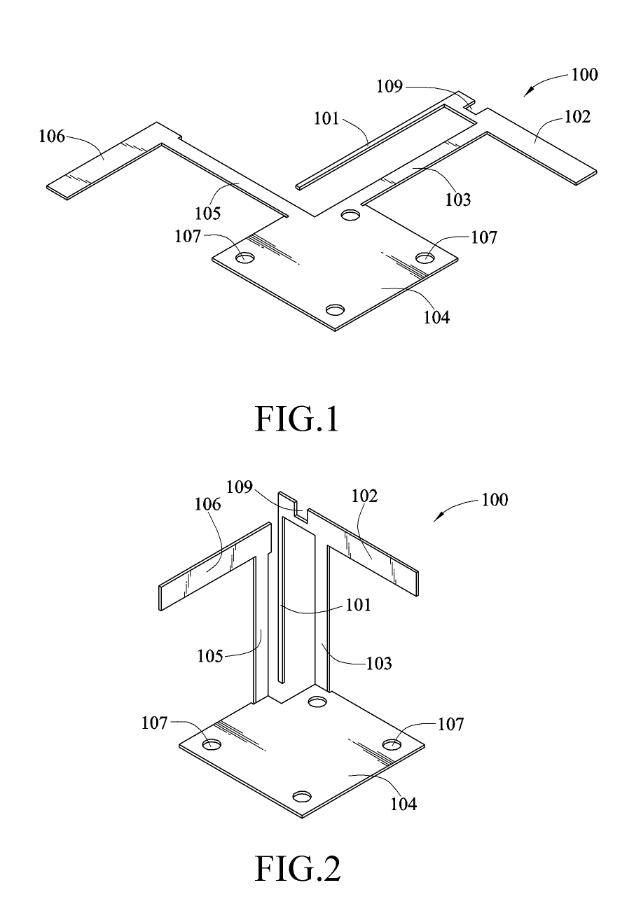

Referring to FIGS. 1 and 2, the first cross-polarized antenna 100 provided by the present invention includes a first transmission portion 101, a first radiation portion 102, a first ground portion 103, a first bottom 104, a second ground portion 105, and a second radiation portion 106. The first transmission portion 101, the first radiation portion 102, the first ground portion 103, the first bottom 104, the second ground portion 105, and the second radiation portion 106 are made of a conductive material, and the conductive material is, but not limited to, metal. In addition, the first transmission portion 101, the first radiation portion 102, the first ground portion 103, the first bottom 104, the second ground portion 105, and the second radiation portion 106 are integrally formed.

A first end of the first transmission portion 101 is connected to a first end of the first radiation portion 102, and a first opening 109 is formed at a side edge of the first end of the first radiation portion 102. A second end of the first radiation portion 102 is connected to a first end of the first ground portion 103. A second end of the first ground portion 103 is connected to a first end of the first bottom 104. A second end of the first bottom 104 is connected to a first end of the second ground portion 105. A second end of the second ground portion 105 is connected to a first end of the second radiation portion 106.

Further, to fix the aforementioned antenna on the substrate 300, a plurality of tapped holes 107 is formed in the first bottom 104, such that the first cross-polarized antenna 100 is locked to the substrate 300 through a plurality of screws. On the other hand, the first cross-polarized antenna 100 may be fixed on the substrate 300 by welding.

Actually, there are various ways for fixing the first cross-polarized antenna 100 on the substrate 300, and the above illustration is only used as an example, instead of limiting the implementation aspect of the present invention.

The structure and components of the second cross-polarized antenna 200 are described as follows.

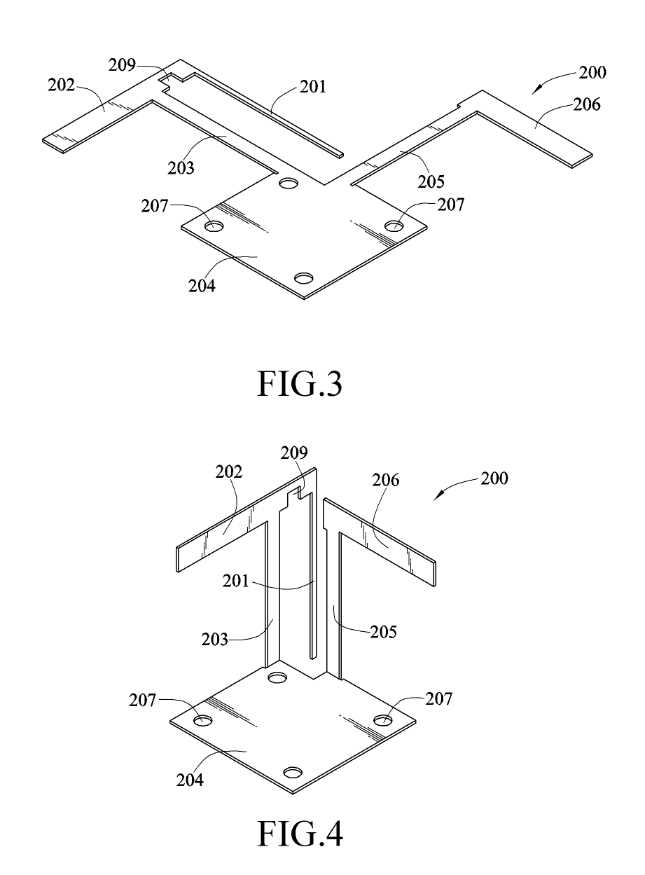

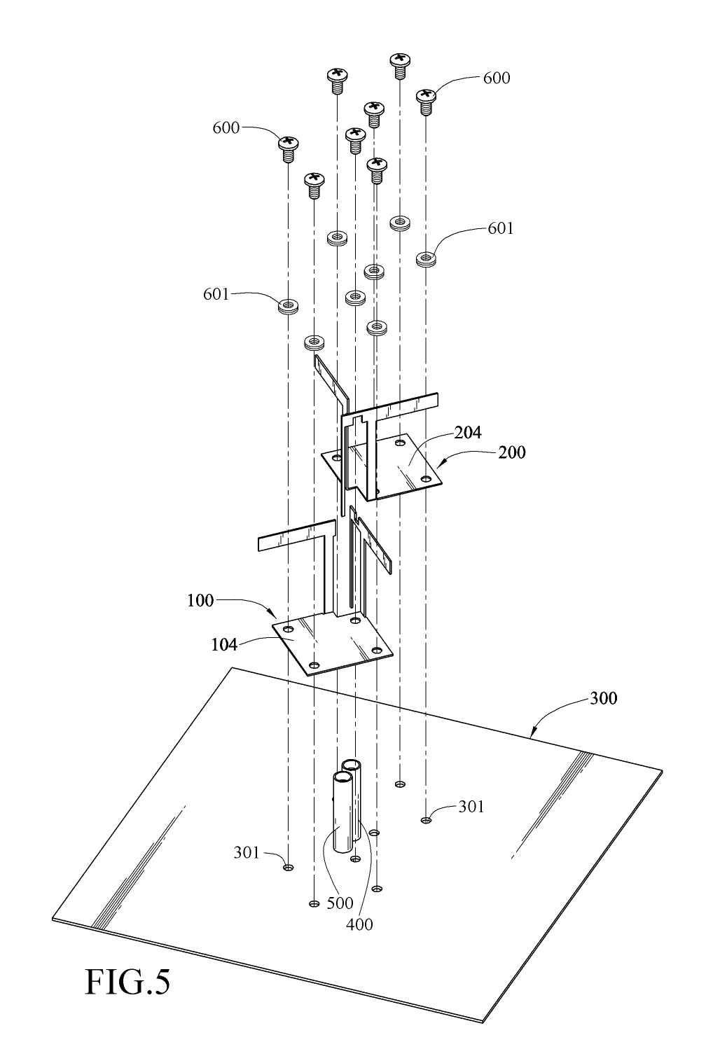

Referring to FIGS. 3 and 4, the second cross-polarized antenna 200 provided by the present invention includes a second transmission portion 201, a third radiation portion 202, a third ground portion 203, a second bottom 204, a fourth ground portion 205, and a fourth radiation portion 206. The second transmission portion 201, the third radiation portion 202, the third ground portion 203, the second bottom 204, the fourth ground portion 205, and the fourth radiation portion 206 are made of a conductive material, and the conductive material is, but not limited to, metal. In addition, the second transmission portion 201, the third radiation portion 202, the third ground portion 203, the second bottom 204, the fourth ground portion 205, and the fourth radiation portion 206 are integrally formed.

A first end of the second transmission portion 201 is connected to a first end of the third radiation portion 202, and a second opening 209 corresponding to the position of the first opening 109 is formed at a side edge of the first end of the third radiation portion 202. A second end of the third radiation portion 202 is connected to a first end of the third ground portion 203. A second end of the third ground portion 203 is connected to a first end of the second bottom 204. A second end of the second bottom 204 is connected to a first end of the fourth ground portion 205. A second end of the fourth ground portion 205 is connected to a first end of the fourth radiation portion 206.

Further, to fix the aforementioned antenna on the substrate 300, a plurality of tapped holes 207 is formed in the second bottom 204, such that the second cross-polarized antenna 200 is locked to the substrate 300 through a plurality of screws. On the other hand, the second cross-polarized antenna 200 may be fixed on the substrate 300 by welding. Actually, there are various ways for fixing the second cross-polarized antenna 200 on the substrate 300, and the above illustration is only used as an example, instead of limiting the implementation aspect of the present invention.

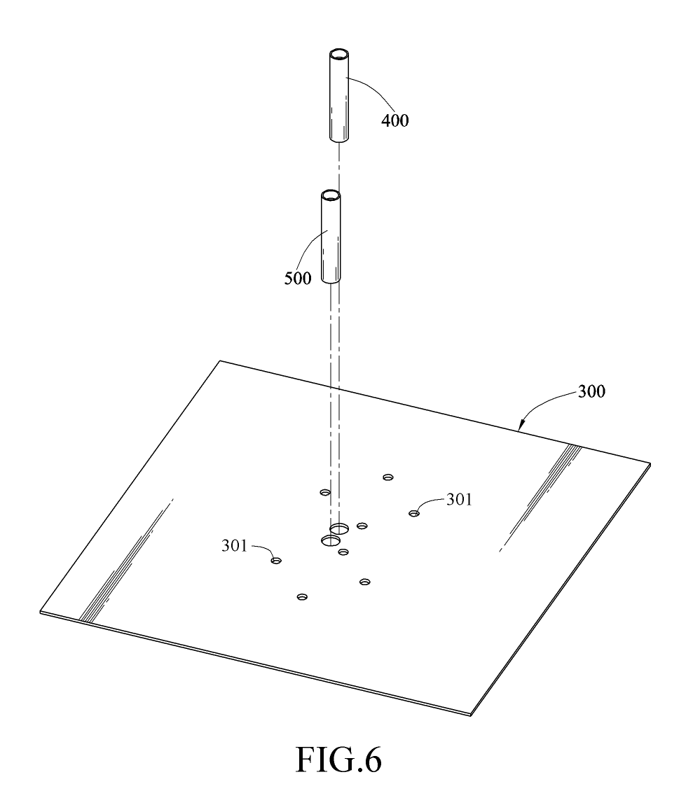

Referring to FIGS. 5 and 6, schematic assembly views of the present invention are shown.

In this embodiment, the first bottom 104 has the plurality of tapped holes 107. The second bottom 204 has the plurality of tapped holes 207. The substrate 300 has a plurality of tapped holes 301 corresponding to the plurality of tapped holes 107 in the first bottom 104 and the plurality of tapped holes 207 in the second bottom 204. In this embodiment, a plurality of screws 600 and a plurality of washers 601 are further provided to penetrate the plurality of tapped holes 107 and the plurality of tapped holes 207, so as to fix the first bottom 104 and the second bottom 204 on the substrate 300. However, the above illustration is only used as an example, instead of limiting the implementation aspect of the present invention.

The first opening 109 in the first radiation portion 102 is corresponding to the second opening 209 in the third radiation portion 202, such that the first radiation portion 102 and the third radiation portion 202 cross each other in space without contacting.

The first impedance converter 400 is disposed on the substrate 300, clad on the first transmission portion 101, and electrically connected to the first cross-polarized antenna 100. The second impedance converter 500 is disposed on the substrate 300, clad on the second transmission portion 201, and electrically connected to the second cross-polarized antenna 200. The first impedance converter 400 is fixed on the substrate 300 by welding. The second impedance converter 500 is fixed on the substrate 300 by welding. In this embodiment, the first impedance converter 400 and the second impedance converter 500 are quarter-wavelength impedance converters. The above illustration is only used as an example, instead of limiting the implementation aspect of the present invention.

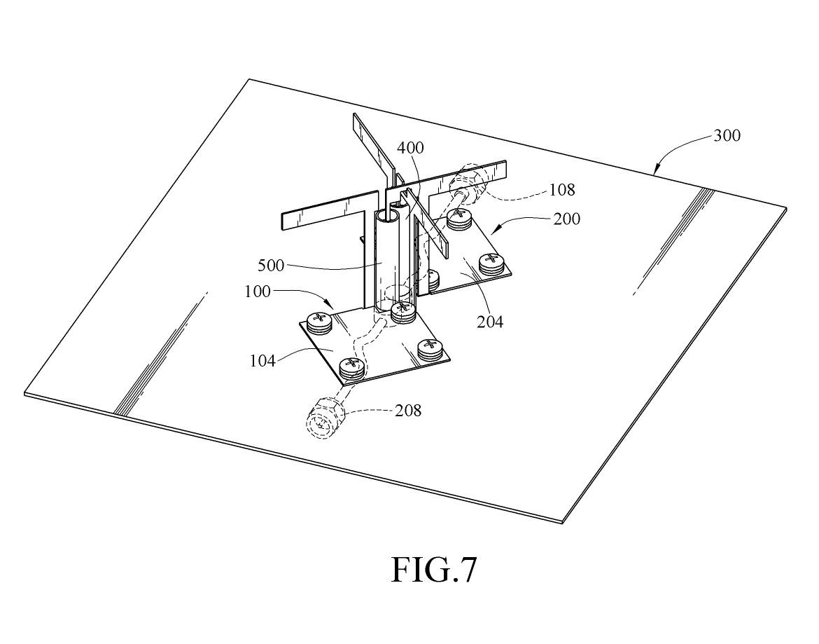

Referring to FIG. 7, in the present invention, a first feed-in line 108 is optionally disposed for transmitting a signal. The first transmission portion 101 is disposed in the first impedance converter 400 and penetrates the substrate 300 to be electrically connected to the first feed-in line 108. Moreover, in the present invention, a second feed-in line 208 is further optionally disposed for transmitting a signal. The second transmission portion 201 is disposed in the second impedance converter 500 and penetrates the substrate 300 to be electrically connected to the second feed-in line 208. The first feed-in line 108 may be connected to the first transmission portion 101 by welding. The second feed-in line 208 may be connected to the second transmission portion 201 by welding.

A signal is first transmitted through the first feed-in line 108 to the first transmission portion 101 clad by the first impedance converter 400, then transmitted from the first transmission portion 101 to the first radiation portion 102, and radiated outward in the form of an electromagnetic wave. In addition, the signal is also radiated outward by the second radiation portion 106. On the other hand, a signal is first transmitted through the second feed-in line 208 to the second transmission portion 201 clad by the second impedance converter 500, then transmitted from the second transmission portion 201 to the third radiation portion 202, and radiated outward in the form of an electromagnetic wave. In addition, the signal is also radiated outward by the fourth radiation portion 206. The second radiation portion 106 may be electrically connected to the second impedance converter 500. The fourth radiation portion 206 may be electrically connected to the first impedance converter 400.

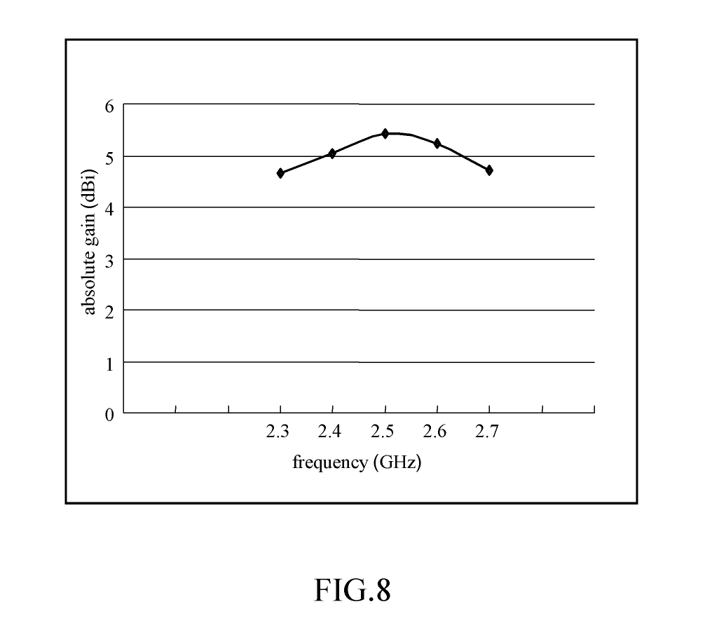

The cross-polarized antenna formed by crossing the first radiation portion 102 and the third radiation portion 202 is capable of receiving electromagnetic waves from different polarization directions effectively, thus reducing the polarization loss. Referring to FIG. 8, the antenna of this embodiment covers a frequency band of 2.3 to 2.7 GHz.

Further, when the antenna provided by the present invention is stricken by lightning, the current is conducted out through the first ground portion 103 and the third ground portion 203, so as to prevent the current from damaging electronic equipments connected to the antenna by passing through the first transmission portion 101 and the second transmission portion 201.

In view of the above, the antenna provided by the present invention is capable of receiving electromagnetic waves from different polarization directions effectively, and the design of an integrally formed metal antenna simplifies the manufacturing and assembling process, thereby reducing the manufacturing cost. Thus, the problems in the prior art are completely solved.

What is claimed is:

1. A cross-polarized antenna, comprising:
a substrate;
a first cross-polarized antenna, fixed on the substrate;
a second cross-polarized antenna, disposed on the substrate without contacting the first cross-polarized antenna;
a first impedance converter, fixed on the substrate, and electrically connected to the first cross-polarized antenna; and
a second impedance converter, fixed on the substrate, and electrically connected to the second cross-polarized antenna.

2. The cross-polarized antenna as claimed in claim 1, wherein the first cross-polarized antenna comprises:
a first transmission portion, disposed on the substrate, and clad by the first impedance converter;
a first radiation portion, having a first end connected to a first end of the first transmission portion, and a first opening facing upward at a side edge of the first end of the first radiation portion;
a first ground portion, having a first end connected to a second end of the first radiation portion;
a first bottom, disposed on the substrate, and having a first end connected to a second end of the first ground portion;
a second ground portion, having a first end connected to a second end of the first bottom, wherein the second ground portion is electrically connected to the second impedance converter; and
a second radiation portion, having a first end connected to a second end of the second ground portion.

3. The cross-polarized antenna as claimed in claim 2, further comprising a first feed-in line electrically connected to the first transmission portion, wherein the first feed-in line is connected to the first transmission portion by welding.

4. The cross-polarized antenna as claimed in claim 2, wherein the first transmission portion, the first radiation portion, the first ground portion, the first bottom, the second ground portion, and the second radiation portion are integrally formed.

5. The cross-polarized antenna as claimed in claim 2, wherein the first bottom has a plurality of tapped holes, such that the first cross-polarized antenna is locked to the substrate through a plurality of screws.

6. The cross-polarized antenna as claimed in claim 2, wherein the first cross-polarized antenna is fixed on the substrate by welding.

7. The cross-polarized antenna as claimed in claim 1, wherein the second cross-polarized antenna comprises:
a second transmission portion, disposed on the substrate, and clad by the second impedance converter;
a third radiation portion, having a first end connected to a first end of the second transmission portion, and a second opening facing downward at a side edge of the first end of the third radiation portion;
a third ground portion, having a first end connected to a second end of the third radiation portion;
a second bottom, disposed on the substrate, and having a first end connected to a second end of the third ground portion;
a fourth ground portion, having a first end connected to a second end of the second bottom, wherein the fourth ground portion is electrically connected to the first impedance converter; and
a fourth radiation portion, having a first end connected to a second end of the fourth ground portion.

8. The cross-polarized antenna as claimed in claim 7, further comprising a second feed-in line electrically connected to the second transmission portion, wherein the second feed-in line is connected to the second transmission portion by welding.

9. The cross-polarized antenna as claimed in claim 7, wherein the second transmission portion, the third radiation portion, the third ground portion, the second bottom, the fourth ground portion, and the fourth radiation portion are integrally formed.

10. The cross-polarized antenna as claimed in claim 7, wherein the second bottom has a plurality of tapped holes, such that the second cross-polarized antenna is locked to the substrate through a plurality of screws.

11. The cross-polarized antenna as claimed in claim 7, wherein the second cross-polarized antenna is fixed on the substrate by welding.

12. The cross-polarized antenna as claimed in claim 1, wherein the first impedance converter is fixed on the substrate by welding.

13. The cross-polarized antenna as claimed in claim 1, wherein the second impedance converter is fixed on the substrate by welding.
